(19) United States
(12) Patent Application Publication
(10) Pub. No.: US 2026/0274176 A1
(43) Pub. Date: Sep. 17, 2026

(54) VEHICLE-MOUNTED CAMERA MOUNTING STRUCTURE

(71) Applicant: TOYOTA JIDOSHA KABUSHIKI KAISHA, Aichi-ken (JP)

(72) Inventors: Tetsuya KITAGAWA, Nagoya-shi (JP); Masayuki AMANO, Nisshin-shi (JP); Tetsuro ENOMOTO, Toyota-shi (JP); Kohji OHTOMO, Nagoya-shi (JP)

(21) Appl. No.: 19/417,382

(22) Filed: Dec. 12, 2025

(30) Foreign Application Priority Data
Mar. 17, 2025 (JP) 2025-042070

(51) Int. Cl. B60R 11/04; B60R 11/00

(52) U.S. Cl. CPC B60R 11/04; B60R 2011/004; B60R 2011/0047

(57) ABSTRACT

The bracket has a base portion, a cover portion, and a hinge portion. An insertion hole for the camera is formed in the base portion. The camera is accommodated in the base portion through the insertion hole. The cover portion closes the insertion hole. The cover portion engages with the base portion. The hinge portion connects the base portion and the cover portion.

### CROSS REFERENCE TO RELATED APPLICATION

This application claims priority to Japanese Patent Application No. 2025-42070, filed on Mar. 17, 2025, which is incorporated herein by reference in its entirety including the specification, claims, drawings, and abstract.

### TECHNICAL FIELD

The present specification discloses a vehicle-mounted camera mounting structure.

### BACKGROUND

The vehicle is provided with an outside camera. The outside camera captures an image of a scene outside the vehicle. The driving control of the vehicle is executed based on the image captured by the external camera.

In JP 2012-35694 A, a bracket for mounting a camera to a vehicle body is disclosed. The camera body is fastened to the bracket by screws. Further, the bracket is provided with an attachment hook. An opening is formed in the body. The camera is fixed to the body by hooking the attachment hook on the edge of the body.

The present specification discloses a vehicle-mounted camera mounting structure which is capable of reducing the number of components as compared with the related art.

### SUMMARY

A vehicle-mounted camera mounting structure is disclosed herein. The mounting structure includes a camera and a bracket. The bracket is configured to fix the camera to an exterior component of a vehicle. The bracket has a base portion, a cover portion, and a hinge portion. An insertion hole for the camera is formed in the base portion. The camera is accommodated in the base portion through the insertion hole. The cover portion closes the insertion hole. The cover portion engages with the base portion. The hinge portion connects the base portion and the cover portion.

According to the above configuration, the number of components required to attach the camera can be reduced as compared with the case where a screw or the like is used.

In addition, the camera may have an imaging surface and an opposing surface opposing the imaging surface. A connection port with a cable is formed on the opposing surface. The connection port protrudes from the opposing surface. A shape of the connection port is vertically asymmetrical or horizontally asymmetrical. A port opening into which the connection port is inserted is formed in the cover portion. The port opening is vertically asymmetrical or horizontally asymmetrical corresponding to the shape of the connection port.

According to the above configuration, it is possible to avoid housing the camera in the bracket in an incorrect orientation.

Further, the exterior component and the bracket may be integrally molded from a resin material.

According to the above configuration, loss of components required for mounting the camera is suppressed.

In addition, the base portion may have a housing portion accommodating the camera. The housing portion has a cross-sectional rectangular shape. A gate-shaped frame is formed on each of a pair of opposed inner surfaces of the housing portion. The pair of frames are provided so as to protrude toward the respective inner surfaces. The camera is accommodated in a gap between the pair of frames. An engagement hook configured to engage the camera is formed in a region, of respective one of the frames, proximate to a side surface of the camera. The cover portion includes a hook pressing piece. The hook pressing piece is inserted into the gate-shaped frame.

When the camera is pressed from the imaging surface, there is a possibility that the engaging hook is opened outward and the camera is detached from the bracket. By disposing the hook pressing piece on the outer side of the engaging hook, opening of the engaging hook can be suppressed.

In addition, the camera may have an imaging surface and an opposing surface opposing the imaging surface. The base portion has a housing portion and a widened portion. The camera is accommodated in the housing portion. The widened portion is connected to an end of the housing portion on a side of the insertion hole. The widened portion is wider than the housing portion. A base-side engagement protrusion is formed on the widened portion. The cover portion has a cover-side engagement protrusion and an elastic piece. The cover-side engagement protrusion engages with the base-side engagement protrusion when the insertion hole is closed. The elastic piece biases the opposing surface of the camera in a state in which the base-side engagement protrusion and the cover-side engagement protrusion are engaged with each other.

According to the above configuration, the camera is supported in the front-rear direction by the elastic piece without requiring a fixing jig.

According to the vehicle-mounted camera mounting structure disclosed in the present specification, the number of components can be reduced as compared with the related art.

### BRIEF DESCRIPTION OF DRAWINGS

Embodiments of the present disclosure will be described based on the following figures, wherein:

FIG. 1 is a view showing an example in which a bracket is attached to a bumper;

FIG. 2 is a front view of the bracket;

FIG. 3 is a rear view of the bracket;

FIG. 4 is a diagram illustrating an assembly process (½) of the vehicle-mounted camera mounting structure;

FIG. 5 is a diagram illustrating an assembly process ( 2/2) of the vehicle-mounted camera mounting structure;

FIG. 6 is a diagram illustrating a cross section taken along line A-A of FIG. 5;

FIG. 7 is a diagram illustrating a cross section taken along line B-B of FIG. 5;

FIG. 8 is a view of the bracket according to the first different example as viewed from the front surface;

FIG. 9 is a rear view of the bracket according to the first example;

FIG. 10 is a diagram illustrating an assembly process (½) of the vehicle-mounted camera mounting structure according to the first alternative example;

FIG. 11 is a diagram illustrating an assembly process ( 2/2) of the vehicle-mounted camera mounting structure according to the first alternative example;

FIG. 12 is a diagram illustrating a cross section taken along line C-C of FIG. 11; and

FIG. 13 is a diagram illustrating a D-D cross section of FIG. 11.

### DESCRIPTION OF EMBODIMENTS

Hereinafter, a vehicle-mounted camera mounting structure according to an embodiment will be described with reference to the drawings. The shapes, materials, numbers, and numerical values described below are for illustrative purposes only. These shapes and the like can be appropriately changed according to the specifications of the vehicle-mounted camera mounting structure. In the following description, the same reference numerals denote the same elements in all the drawings.

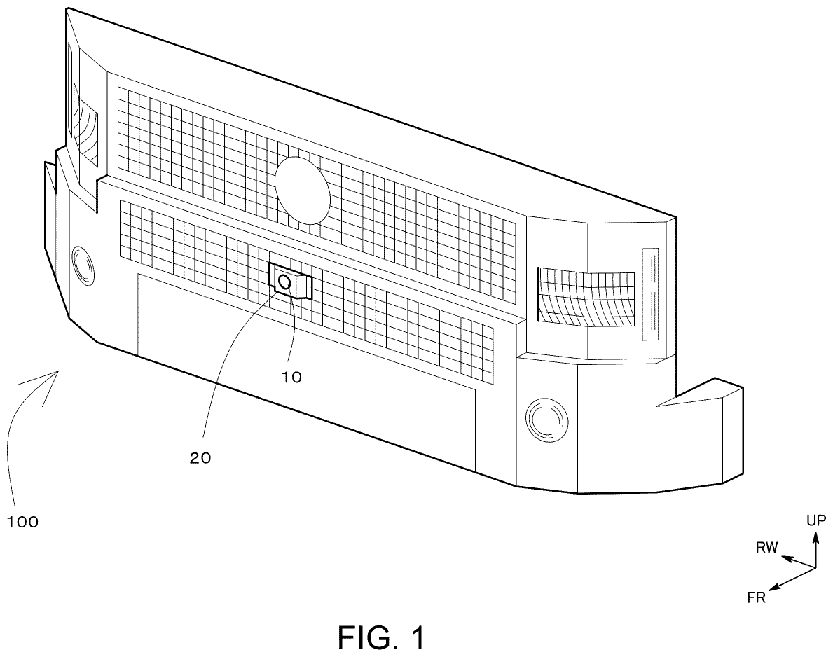

In FIGS. 1 to 13, an orthogonal coordinate system including an FR axis, an RW axis, and an UP axis is used to represent the position and direction of each configuration. The FR axis is a vehicle front-rear direction axis whose forward direction is the vehicle front side. The RW axis is a vehicle width direction axis whose forward direction is the right side of the vehicle. The UP axis is a vehicle vertical axis whose upward direction is a positive direction.

### 1. Overall Configuration

FIG. 1 illustrates a vehicle-mounted camera mounting structure according to the present embodiment. The structure includes a camera 10 and a bracket 20.

As described in detail below, the camera 10 is secured to exterior parts of the vehicle via bracket 20. As an example of the exterior component, a front bumper 100 is illustrated in FIG. 1.

For example, the camera 10 and the bracket 20 are disposed at a center portion of the front bumper 100 in the vehicle width direction. In the following description, it is assumed that the camera 10 and the bracket 20 are disposed in the center portion in the vehicle width direction as shown in FIG. 1, and the arrangement of each portion and the like will be described.

The front bumper 100 is made of a resin material. As will be described later, the bracket 20 is also made of a resin material. For example, the front bumper 100 and the bracket 20 are integrally molded products made of the same resin material. By using the bracket 20 as a part of the front bumper, the number of components of the mounting structure of the camera 10 can be reduced.

The bracket 20 may be integrally molded with a resin-made exterior component different from the front bumper 100. For example, the rear bumper or the fender panel may be integrally molded with the bracket 20.

### 2. Camera

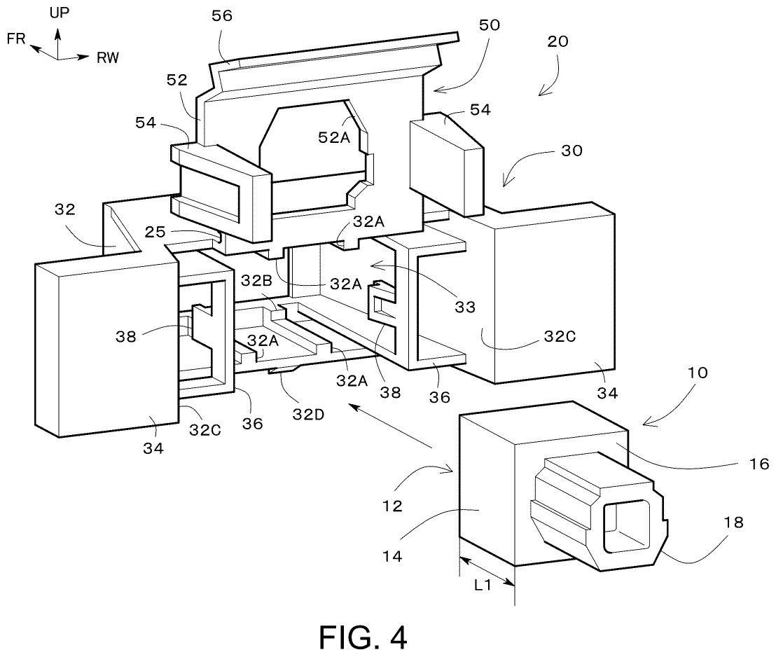

Referring to FIG. 4, camera 10 captures an image of a scene outside the vehicle. The captured image is transmitted to an electronic control unit (not shown) of the vehicle. The electronic control unit analyzes the captured image and performs vehicle control according to the situation.

The camera 10 includes a lens, an image sensor, and the like. The camera 10 includes, for example, a cuboid or rectangular parallelepiped main body and a connection port 18. The body of the camera 10 includes an imaging surface 12, a side surface 14, and an opposing surface 16. The opposing surface 16 faces the imaging surface 12. A lens (not shown) or the like is disposed on the imaging surface 12. When the imaging surface 12 is the front surface of the camera 10, the opposing surface 16 corresponds to the back surface.

A connection port 18 is formed on the opposing surface 16. A cable (not shown) is inserted into the connection port 18. The connection port 18 is a cylindrical component and protrudes from the opposing surface 16.

In order to prevent the cable from being inserted in an incorrect orientation (angle), the shape of the connection port 18 is asymmetrical in the up-down direction or asymmetrical in the left-right direction. FIG. 4 illustrates a vertically asymmetrical connection port 18. As described later, the connection port 18 is inserted into the port opening 52A of the bracket 20. The port opening 52A is vertically asymmetrical or horizontally asymmetrical depending on the shape of the connection port 18. FIG. 4 illustrates a vertically asymmetric port opening 52A.

### 3. Bracket

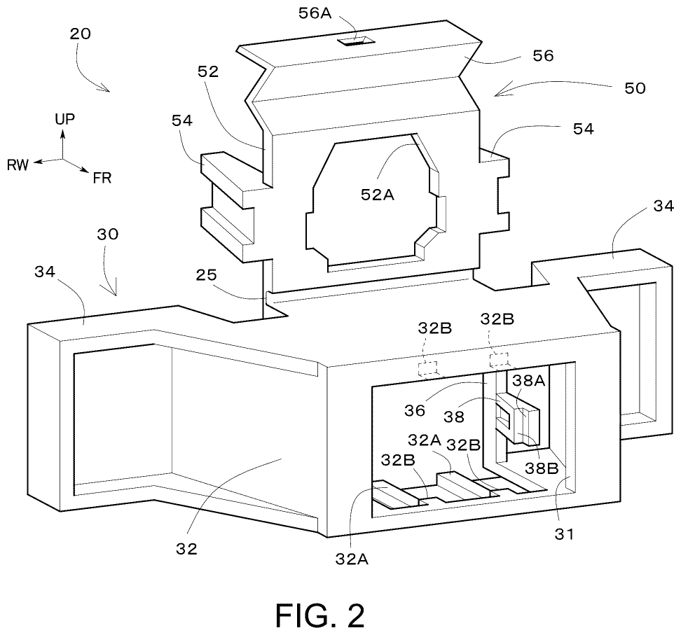

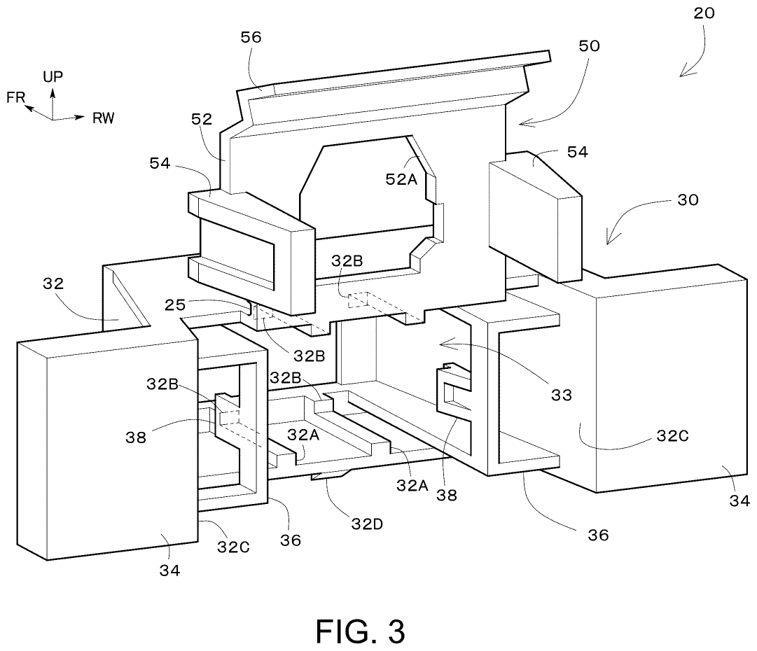

FIGS. 2 and 3 illustrate a single perspective view of the bracket 20. For example, FIGS. 2 and 3 illustrate a state in which the bracket 20 is cut out from the front bumper 100 (see FIG. 1). FIG. 2 illustrates the front side of the bracket 20. FIG. 3 illustrates the back side of the bracket 20. The bracket 20 is made of a resin material.

The bracket 20 includes a base portion 30, a cover portion 50, and a hinge portion 25. The base portion 30 accommodates the camera 10. The cover portion 50 closes the insertion hole 33 of the base portion 30. The cover portion 50 engages with the base portion 30. Further, the hinge portion 25 connects the base portion 30 and the cover portion 50.

An insertion hole 33 for the camera 10 is formed in the base portion 30. The camera 10 is accommodated in the base portion 30 through the insertion hole 33. The base portion 30 includes a housing portion 32 and flanges 34, 34. The flanges 34, 34 extend outward in the vehicle width direction from the rear end of the housing portion 32. The flanges 34, 34 are connected to exterior parts such as the front bumper 100.

The camera 10 is accommodated in the housing portion 32. The housing portion 32 has, for example, a rectangular cross section. An imaging opening 31 is formed at the front end of the housing portion 32. Further, an engagement hook 32D is formed at the lower end of the housing portion 32. The engagement hook 32D engages with an engagement hole 56A formed in the extension piece portion 56 of the cover portion 50.

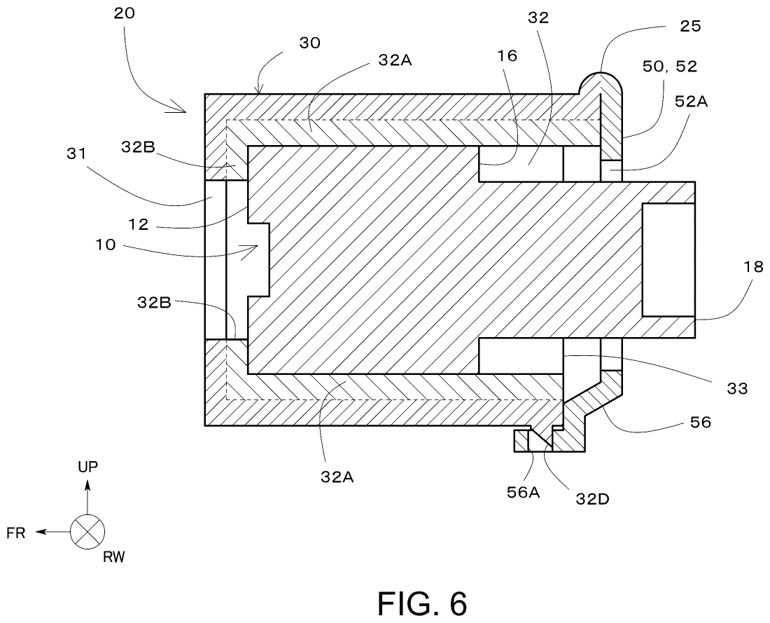

A guide piece 32A and a protrusion 32B are provided on the inner surface of the housing portion 32. The guide piece 32A extends from the rear end to the front end of the inner surface of the housing portion 32. The protrusion 32B protrudes from the front end of the guide piece 32A toward the imaging opening 31. Referring to FIG. 6, the imaging surface 12 of the camera 10 abuts on the protrusion 32B. That is, the protrusion 32B is a part of the positioning mechanism of the camera 10 in the bracket 20. Referring to FIG. 3, a plurality of guide pieces 32A and a plurality of protrusions 32B are provided on the inner surface of the housing portion 32.

A gate-shaped frame 36 is formed on each of the inner surfaces 32C, 32C of the housing portion 32. The frames 36 protrude toward the inner surfaces 32C, 32C. As described later, the hook pressing piece 54 of the cover portion 50 is inserted into the frame 36 (inside the gate).

A gap between the pair of frames 36, 36 serves as an insertion hole 33 for the camera 10. That is, the camera 10 is inserted and accommodated in the gap between the frames 36, 36. An engagement hook 38 is formed on the frame 36.

The engagement hook 38 is formed in a region of each frame close to the side surface 14 (see FIG. 4) of the camera 10. That is, the engagement hook 38 is provided on the vehicle width direction inner side portion of the frame 36. The separation distance between the engagement hook 38 and the protrusion 32B may be equal to the dimension L1 (see FIG. 4) of the main body of the camera 10 in the front-rear direction. As described later, the engagement hook 38 engages with the camera 10. The hook pressing piece 54 is disposed on the vehicle width direction outer side of the engagement hook 38.

Referring to FIGS. 2 and 3, the cover portion 50 closes the insertion hole 33. The cover portion 50 engages with the base portion 30 when the insertion hole 33 is closed.

The cover portion 50 includes a cover main body 52, hook pressing pieces 54 and 54, and an extension piece portion 56. The cover main body 52 is a flat plate-shaped portion. A port opening 52A is formed in the cover main body 52. The connection port 18 of the camera 10 is inserted into the port opening 52A. The port opening 52A is vertically asymmetrical or horizontally asymmetrical corresponding to the shape of the connection port 18. In the example of FIGS. 2 and 3, the port opening 52A is vertically asymmetrical.

Hook pressing pieces 54, 54 are provided on both sides of the cover main body 52 in the vehicle width direction. The hook pressing piece 54 protrudes from the cover main body 52. The hook pressing pieces 54 extend in the vehicle front-rear direction. In addition, for example, the hook pressing piece 54 has a tapered shape that becomes narrower toward the tip from the cover main body 52.

In FIGS. 2 and 3, an extension piece portion 56 is provided at the upper end of the cover main body 52. The extension piece portion 56 extends in the same direction as the protruding direction of the hook pressing piece 54. An engagement hole 56A is formed in the extension piece portion 56. As illustrated in FIG. 6, the engagement hole 56A engages with the engagement hook 32D of the base portion 30.

The hinge portion 25 connects the base portion 30 and the cover portion 50. The hinge portion 25 is thinner than the base portion 30 and the cover portion 50, for example. The rotation axis of the cover portion 50 by the hinge portion 25 is directed, for example, in the vehicle width direction.

### 4. Assembly Process of Vehicle-Mounted Camera Mounting Structure

Referring to FIG. 4, camera 10 is inserted into insertion hole 33 of bracket 20 from imaging surface 12. Referring to FIGS. 4 and 6, the camera 10 is inserted into the housing portion 32 along the guide piece 32A.

At this time, the camera 10 is inserted into the housing portion 32 in a state in which the side surface 14 of the camera 10 pushes and bends the engagement hook 38 outward in the vehicle width direction. When the opposing surface 16 of the camera 10 climbs over the engagement hook 38, the contact surface 38A (see FIG. 2) of the engagement hook 38 contacts the side surface 14 of the camera 10. Further, the contact surface 38B of the engagement hook 38 contacts the opposing surface 16 of the camera 10. At this time, the imaging surface 12 of the camera 10 abuts on the protrusion 32B.

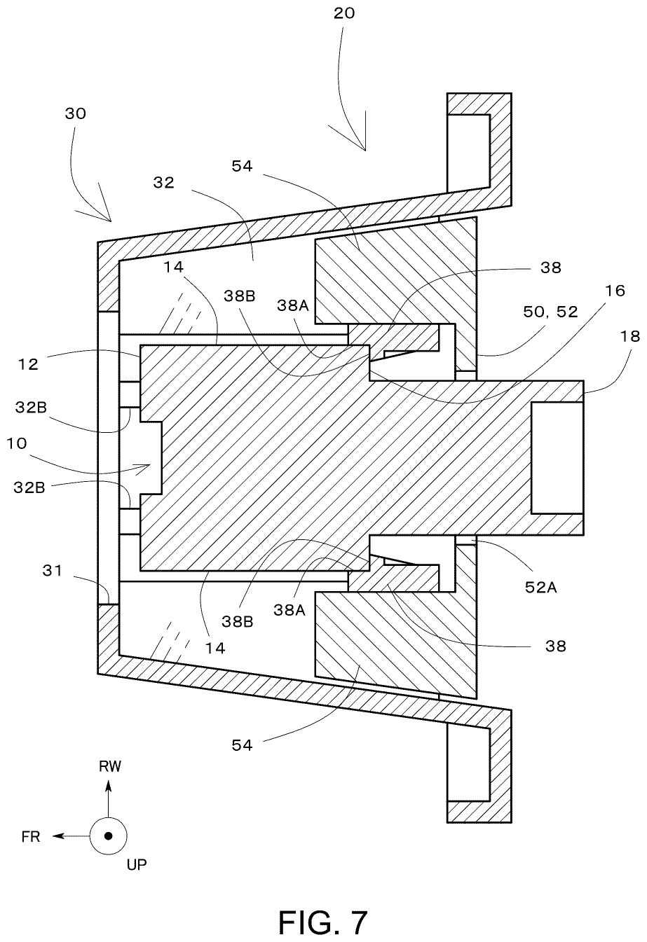

With reference to FIG. 7, positioning of the camera 10 in the front-rear direction is performed by the protrusion 32B and the contact surface 38B of the engagement hook 38. In addition, positioning of the camera 10 in the vehicle width direction is performed by the contact surface 38A of the engagement hook 38, 38.

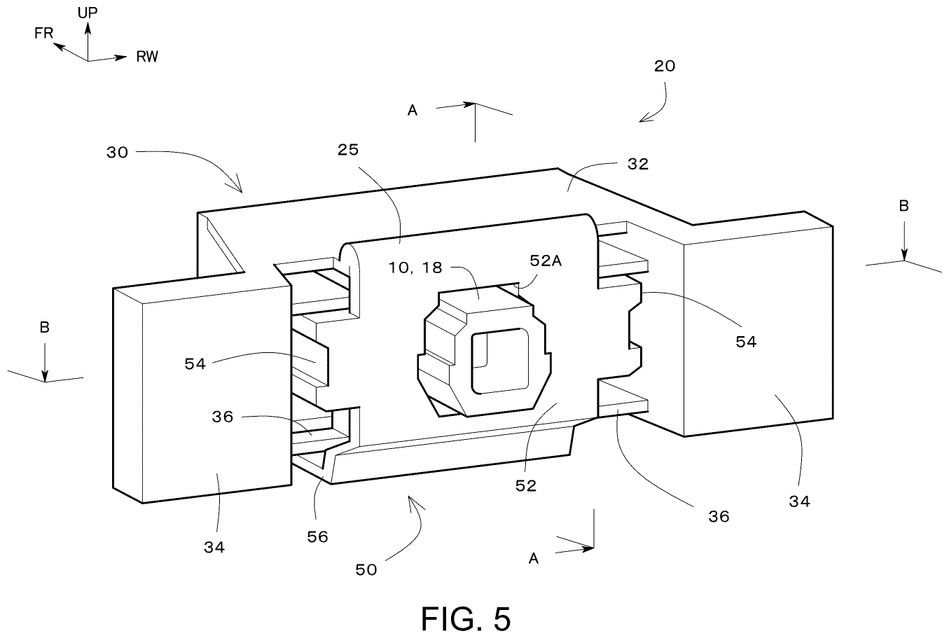

Referring to FIG. 5, the cover portion 50 is folded back to close the insertion hole 33 (see FIG. 4). At this time, when the angle around the optical axis of the camera 10 is different from the correct angle as shown in FIG. 5, the connection port 18 cannot pass through the port opening 52A and hits the cover main body 52. That is, the closing of the cover portion 50 is interrupted. In this way, the correctness of the attachment angle of the camera 10 can be confirmed by using the cover portion 50.

FIG. 6 illustrates a cross section taken along line A-A of FIG. 5. Referring to FIGS. 5 and 6, when the attachment angle of camera 10 is correct, connection port 18 is inserted into port opening 52A. Then, the engagement hole 56A of the extension piece portion 56 of the cover portion 50 is caught by the engagement hook 32D of the base portion 30. At this time, referring to FIG. 4 and FIG. 7 (B-B cross section of FIG. 5), the hook pressing piece 54 of the cover portion 50 is inserted into the frame 36 (inside the gate). That is, the hook pressing piece 54 is disposed on the vehicle width direction outer side of the engagement hook 38.

If the camera 10 is pushed rearward from the imaging surface 12, the engagement hook 38 may open outward in the vehicle width direction, and the camera may be detached from the engagement hook 38. By disposing the hook pressing piece 54 on the outer side in the vehicle width direction of the engagement hook 38, the opening of the engagement hook 38 to the outer side in the vehicle width direction is suppressed.

### 5. Bracket According to First Alternative Example

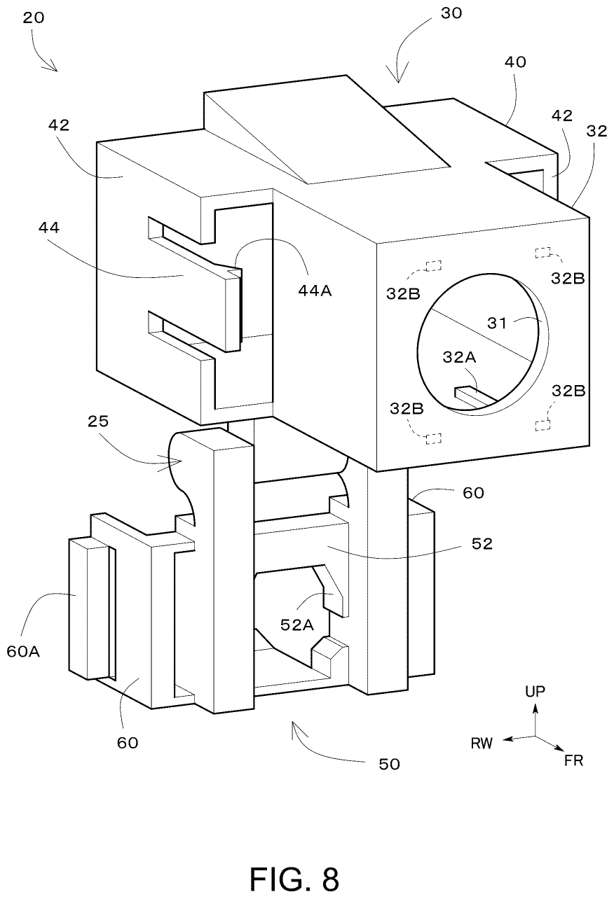

FIGS. 8 to 13 illustrate a bracket 20 according to a first alternative example. As in the embodiment of FIGS. 1-7, the bracket 20 is integrally molded with an exterior component such as the front bumper 100 (see FIG. 1).

In the bracket 20 according to the first different example, the base portion 30 includes the widened portion 40 in addition to the housing portion 32. The cover portion 50 is provided with side walls 60 and 60 and elastic pieces 62 and 62. Note that structures similar to those in FIGS. 1 to 7, such as the housing portion 32 of the base portion 30 and the port opening 52A of the cover portion 50, will not be described below as appropriate.

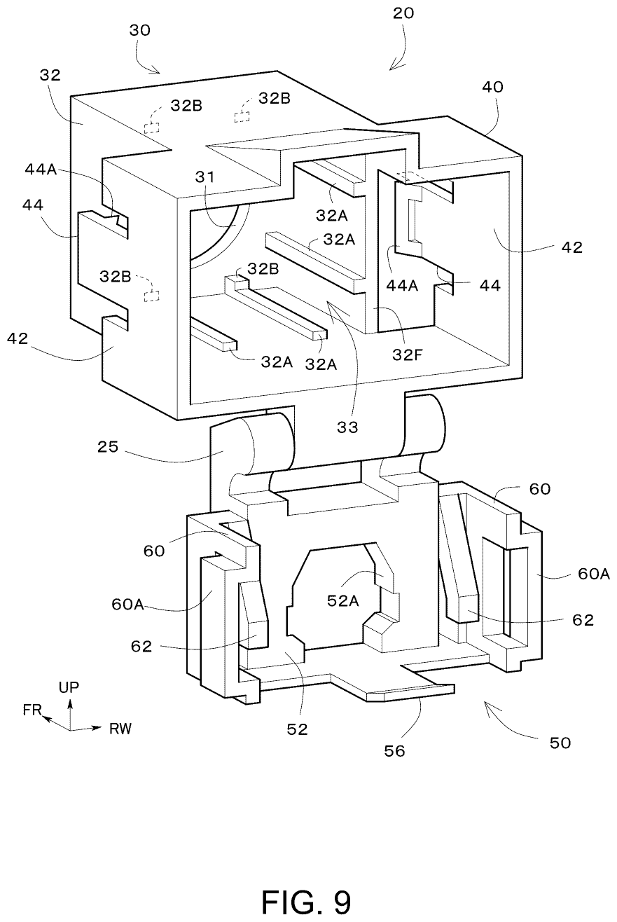

Referring to FIGS. 8 and 9, the base portion 30 and the cover portion 50 are molded as separate bodies, for example. The base portion 30 and the cover portion 50 are rotatably connected to each other at the hinge portion 25.

The widened portion 40 of the base portion 30 is connected to the rear end of the housing portion 32. That is, the widened portion 40 is connected to the end of the housing portion 32 on the insertion hole 33 side.

The widened portion 40 is wider than the housing portion 32. That is, the side wall 42 of the widened portion 40 is disposed outside the side wall 32F of the housing portion 32 in the vehicle width direction. The upper wall and the lower wall of the widened portion 40 extend from the upper wall and the lower wall of the housing portion 32. A gap is provided between the side wall 32F of the housing portion 32 and the side wall 42 of the widened portion 40. As described later, the side wall 60 of the cover portion 50 is inserted into the gap.

An extension piece 44 is provided at the front end of the side wall 42. The extension piece 44 extends forward. A pedestal-side engagement projection 44A is provided at the front end of the extension piece 44. The pedestal-side engagement projection 44A protrudes inward in the vehicle width direction.

The cover main body 52 of the cover portion 50 is provided with a pair of elastic pieces 62, 62. The elastic pieces 62, 62 are provided on both sides of the port opening 52A in the vehicle width direction. Further, for example, a portion of the cover main body 52 facing the elastic pieces 62, 62 is opened.

Since the bracket 20 is made of a resin material, the elastic pieces 62 and 62, which are parts of the bracket 20, have elasticity based on the characteristics of the resin material. That is, the elastic pieces 62 can bend in the vehicle front-rear direction. When no load is applied, the elastic pieces 62, 62 are inclined along the extending direction of the side wall 60.

Side walls 60, 60 are connected to both side ends of the cover main body 52 in the vehicle width direction. The side walls 60, 60 extend in the same direction as the extension piece portion 56. Cover-side engagement protrusions 60A, 60A are provided at the distal ends of the side walls 60, 60. The cover-side engagement protrusions 60A, 60A protrude outward in the vehicle width direction from the side walls 60, 60.

As will be described later, in the bracket 20 according to the first different example, the cover portion 50 is engaged with the base portion 30 when the pedestal-side engagement projection 44A and the cover-side engagement projection 60A are engaged with each other. Therefore, the engagement hole is not formed in the extension piece portion 56.

### 6. Assembly Process of Vehicle-Mounted Camera Mounting Structure According to First Alternative Example

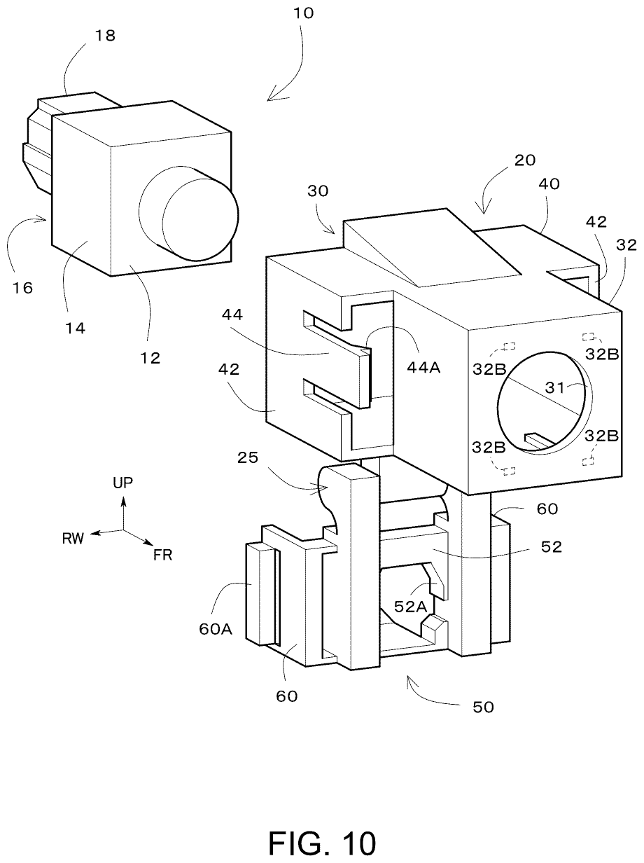

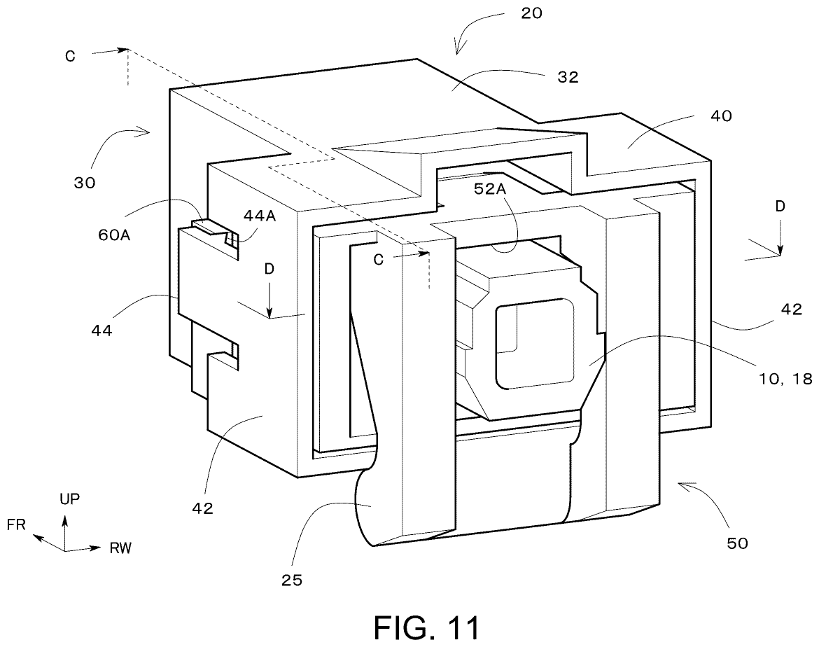

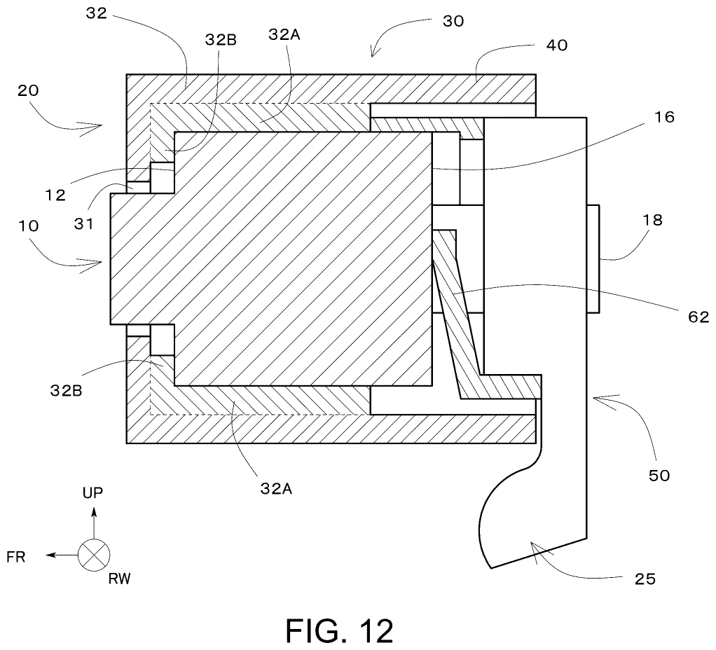

FIGS. 10 to 13 illustrate an assembly process of the vehicle-mounted camera mounting structure according to the first alternative example. The camera 10 is inserted into the housing portion 32 from the imaging surface 12. Referring to FIGS. 9 and 12 (C-C cross section of FIG. 11), the camera 10 is inserted into the housing portion 32 along the guide piece 32A.

When the imaging surface 12 of the camera 10 abuts on the protrusion 32B, the cover portion 50 is folded back. As in the embodiment of FIGS. 1 to 7, when the attachment angle of the camera 10 is correct, the connection port 18 is inserted into the port opening 52A.

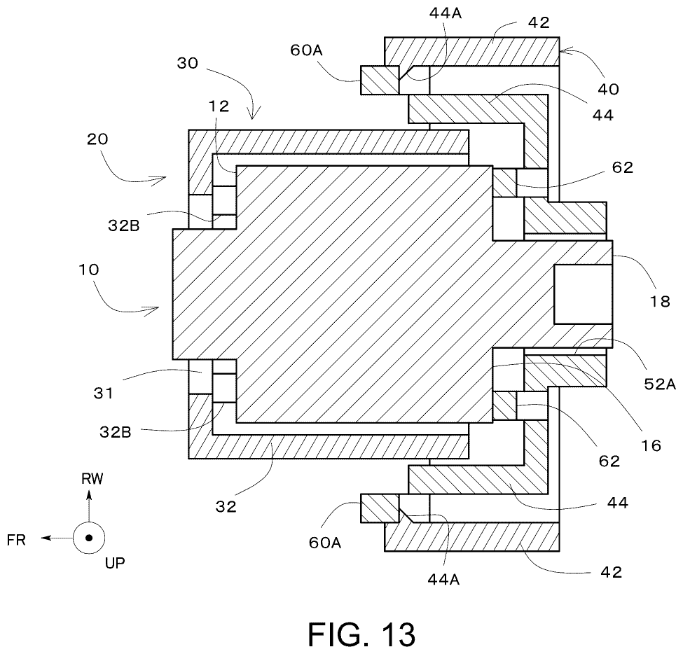

Referring to FIGS. 9 and 11, in the process in which cover portion 50 closes insertion hole 33, cover-side engagement projection 60A pushes and bends pedestal-side engagement projection 44A and extension piece 44 of widened portion 40 outward in the vehicle width direction. When the cover-side engagement projection 60A rides over the pedestal-side engagement projection 44A, both projections engage with each other as illustrated in FIG. 13 (cross section taken along line D-D in FIG. 11). When the cover-side engagement projection 60A and the pedestal-side engagement projection 44A are engaged with each other, the cover portion 50 and the base portion 30 are engaged with each other.

In a state where the cover-side engagement projection 60A and the pedestal-side engagement projection 44A are engaged with each other, as illustrated in FIG. 12, the elastic piece 62 biases the opposing surface 16 of the camera 10 forward. That is, the positioning of the camera 10 in the front-rear direction is performed by the elastic piece 62 and the protrusion 32B.

The present disclosure is not limited to the present embodiments described above, and includes all changes and modifications without departing from the technical scope or the essence of the present disclosure defined by the claims.

1. A vehicle-mounted camera mounting structure comprising:
a camera; and
a bracket configured to fix the camera to an exterior component of a vehicle; wherein
the bracket has a base portion, a cover portion, and a hinge portion,
an insertion hole for the camera is formed in the base portion, and the camera is accommodated in the base portion through the insertion hole;
the cover portion closes the insertion hole, and the cover portion engages with the base portion; and
the hinge portion connects the base portion and the cover portion.

2. The vehicle-mounted camera mounting structure according to claim 1, wherein
the camera has an imaging surface and an opposing surface opposing the imaging surface;
a connection port with a cable is formed on the opposing surface;
the connection port protrudes from the opposing surface;
a shape of the connection port is vertically asymmetrical or horizontally asymmetrical;
a port opening into which the connection port is inserted is formed in the cover portion; and
the port opening is vertically asymmetrical or horizontally asymmetrical corresponding to the shape of the connection port.

3. The vehicle-mounted camera mounting structure according to claim 1, wherein:
the exterior component and the bracket are integrally molded from a resin material.

4. The vehicle-mounted camera mounting structure according to claim 1, wherein:
the base portion has a housing portion having a cross-sectional rectangular shape, and the housing portion accommodates the camera;
a gate-shaped frame is formed on each of a pair of opposed inner surfaces of the housing portion, and the pair of frames are provided so as to protrude toward the respective inner surfaces;
the camera is accommodated in a gap between the pair of frames;
an engagement hook configured to engage the camera is formed in a region, of respective one of the frames, proximate to a side surface of the camera; and
the cover portion includes a hook pressing piece inserted into the gate-shaped frame.

5. The vehicle-mounted camera mounting structure according to claim 1, wherein
the camera has an imaging surface and an opposing surface opposing the imaging surface;
the base portion has a housing portion and a widened portion;
the camera is accommodated in the housing portion;
the widened portion is connected to an end of the housing portion on a side of the insertion hole, and the widened portion is wider than the housing portion;
a base-side engagement protrusion is formed on the widened portion;
the cover portion has a cover-side engagement protrusion and an elastic piece;
the cover-side engagement protrusion engages with the base-side engagement protrusion when the insertion hole is closed; and
the elastic piece biases the opposing surface of the camera in a state in which the base-side engagement protrusion and the cover-side engagement protrusion are engaged with each other.
